(19) United States
(12) Patent Application Publication
(10) Pub. No.: US 2009/0187821 A1
(43) Pub. Date: Jul. 23, 2009

(54) IMAGE FORMING APPARATUS AND METHOD OF DISPLAYING FILE LIST THEREIN

(75) Inventors: Jun-hyung Ha, Seoul (KR); Sang-hyun Park, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/180,785

(22) Filed: Jul. 28, 2008

(30) Foreign Application Priority Data
Aug. 23, 2007 (KR) 2007-85173

(51) Int. Cl. G06F 17/00

(52) U.S. Cl. 715/274; 715/273

(57) ABSTRACT

The image forming apparatus includes a display part on which a first and second list of a file, which are to be printed, is displayed and a controller which controls a display of the first list of a file which corresponds to a predetermined condition simultaneously with a display of the second list of a file which does not correspond to the predetermined condition, the second list displayed on the display part by a different display method than the first list.

### CROSS-REFERENCE TO RELATED APPLICATIONS

This application claims priority from Korean Patent Application No. 10-2007-0085173, filed on Aug. 23, 2007 in the Korean Intellectual Property Office, the disclosure of which is incorporated herein in its entirety by reference.

### BACKGROUND OF THE INVENTION

1. Field of the Invention

The present general inventive concept relates to an image forming apparatus which can display a list of a file which is to be displayed, and a method of displaying a file list therein.

2. Description of the Related Art

In general, an image forming apparatus processes various formats of files which are to be printed into an image and forms a visible image on a printing medium, such as paper, with a developer or ink. The image forming apparatus may include a display part, such as a monitor, to display a list of the files to be printed.

The files which are to be printed may be displayed as icons, file names or the like, or through a print preview function. The print preview function has an advantage over the other display methods since a user can directly view a file which is to be printed. In addition, in the print preview function, a file which is to be printed is rendered into an image having a relatively low resolution and a relatively small size as compared with an original image.

However, conventional image forming apparatus can only employ one of the various display methods. That is, conventional image forming apparatus can only display files, which are to be printed, by only one of the various display methods, including by icons, by file names, by the print preview function and the like or by a list thereof. For example, if the print preview function is selected, all files which are to be printed would be displayed by the print preview function. In this case, all of the files which are to be printed would be rendered for display, which would thereby cause a significant burden on the image forming apparatus and would also require a large amount of time to generate a display.

### SUMMARY OF THE INVENTION

The present general inventive concept will be set forth in part in the description which follows and, in part, will be obvious from the description, or may be learned by practice of the present general inventive concept.

The present general inventive concept provides an image forming apparatus which can classify a plurality of files which are to be printed according to a predetermined condition and can display each file by different display methods.

The foregoing and/or other aspects and utilities of the present general inventive concept may be achieved by providing a method of displaying a file list in an image forming apparatus, the method including determining a classification condition of a file, which is to be printed, corresponding to a first display method to display the file list of the files which are to be printed and displaying the file list of the file corresponding to the classification condition by the first display method, and at the same time, displaying a file list of remaining files by a second display method, the second display method is different from the first display method.

The first and second display methods may be selected among a print preview, a schematic file name, a detailed file name, a slide show, a large icon, and a small icon.

The first display method may include the print preview, and the second display method may include any display method other than the print preview display method.

The classification condition may be inputted through the image forming apparatus or through a host device connected to the image forming apparatus.

The classification condition may include at least one among a format of the file which is to be printed, a file generation date, presence of a predetermined character string included in a file name or meta information, presence of fax communication, resolution, and color.

The file, which is to be printed, may be stored in at least one of a memory provided in the image forming apparatus, a portable memory which is connectable to the image forming apparatus, and a host device which is connected to the image forming apparatus.

The foregoing and/or other aspects and utilities of the present general inventive concept can be also achieved by providing an image forming apparatus including a display part on which a first and second list of a file which are to be printed is displayed and a controller which controls a display of the first list of a file which corresponds to a predetermined condition simultaneously with a display of the second list of a file which does not correspond to the condition, the second list displayed on the display part by a different display method than the first list.

The different display methods may be selected among a print preview, a schematic file name, a detailed file name, a slide show, a large icon, and a small icon.

The first list of the file which corresponds to the predetermined condition may be displayed as the print preview, and the second list of the file which does not correspond to the predetermined condition may be displayed in any display method other than the print preview display method.

The image forming apparatus may further include a printing part which prints an image processed from the first and/or second list onto a printing medium.

The foregoing and/or other aspects and utilities of the present general inventive concept can be also achieved by providing a method of receiving a signal representing a list of one or more files, comparing the signal with a classification condition corresponding to a first display method, displaying the signal using the first display method when the signal corresponds to the classification condition and using a second display method when the signal does not correspond to the classification condition.

The second display method may be displayed simultaneously with the first display method.

The first and second display methods may be selected among a print preview, a schematic file name, a detailed file name, a slide show, a large icon and a small icon.

The classification condition may be inputted through the image forming apparatus and/or through a host device connected to the image forming apparatus.

The classification condition may include at least one among a format of the file which is to be printed, a file generation date, presence of a predetermined character string included in a filed name or meta information, presence of fax communication, resolution, and color.

The foregoing and/or other aspects and utilities of the present general inventive concept can be also achieved by providing an image forming apparatus including an image forming unit, and a controller which receives a file signal representing a file list of one or more files, determines whether each file within the file list corresponds to a plurality of conditions, transmits a first signal when a file corresponds to a first condition and a second signal when a file corresponds to a second condition, wherein the first signal represents a first display method and the second signal represents a second display method, the first display method displayed simultaneously with the second display method.

The controller may transmit the first and second signal to a displaying part to display the first and second signals.

The first and second display methods may be selected among a print preview, a schematic file name, a detailed file name, a slide show, a large icon, and a small icon.

The first display method may include the print preview, and the second display method may include any display method other than the print preview display method.

The image forming apparatus may further include a printing part which prints an image processed from the first and/or second signal onto a printing medium.

The foregoing and/or other aspects and utilities of the present general inventive concept can be also achieved by providing a method of displaying a list of one or more files in an image forming apparatus, the method includes generating a signal to be displayed on a screen, the signal including a first image representing a first file according to a first display method and a second image representing a second file according to a second display method.

The foregoing and/or other aspects and utilities of the present general inventive concept can be also achieved by providing an image forming system including an image forming apparatus having an image forming unit and a controller which receives a file signal representing a file list of one or more files, determines whether each file within the file list corresponds to a plurality of conditions, transmits a first signal when a file corresponds to a first condition and a second signal when a file corresponds to a second condition, wherein the first signal represents a first display method and the second signal represents a second display method, the first display method displayed simultaneously with the second display method, and a host which is connected to the image forming apparatus to control the image forming apparatus.

The controller may transmit the first and second signal to a displaying part to display the first and second signals.

The first and second display methods may be selected among a print preview, a schematic file name, a detailed file name, a slide show, a large icon, and a small icon.

The first display method may include the print preview, and the second display method may include any display method other than the print preview display method.

The image forming system may further include a printing part which prints an image processed from the first and/or second signal onto a printing medium.

### BRIEF DESCRIPTION OF THE DRAWINGS

The above and/or other aspects and utilities of the present general inventive concept will become apparent and more readily appreciated from the following description of the exemplary embodiments, taken in conjunction with the accompanying drawings, in which:

FIG. 1 is a block diagram illustrating an image forming apparatus according to an exemplary embodiment of the present general inventive concept;

FIGS. 2A and 2B are flowcharts illustrating a method of displaying a list of one or more files in an image forming apparatus according to an exemplary embodiment of the present general inventive concept; and

FIG. 3 is a view which illustrates an example of lists displayed according to the display method in FIGS. 2A and 2B.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to like elements throughout. The exemplary embodiments are described below in order to explain the present general inventive concept by referring to the figures.

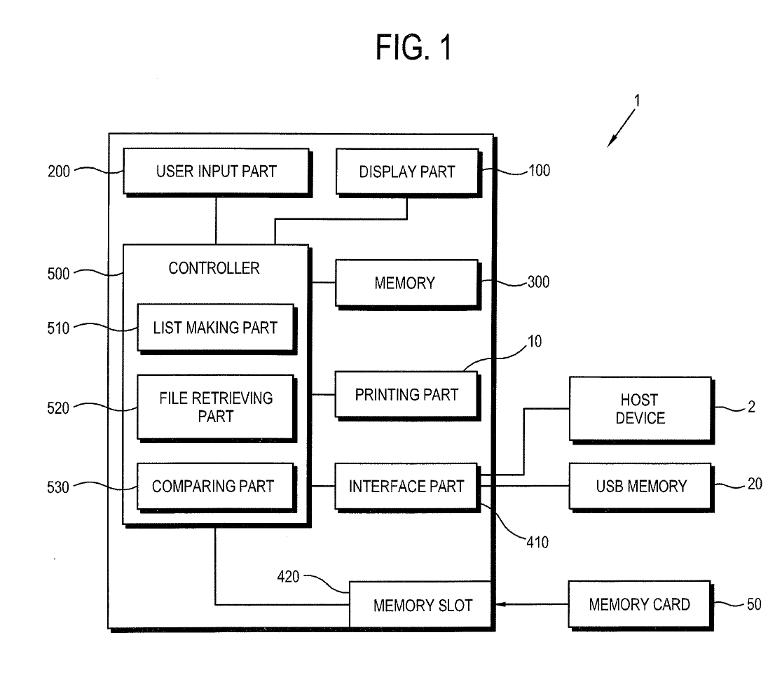

Referring to FIG. 1, an image forming apparatus 1 according to an exemplary embodiment of the present general inventive concept classifies a plurality of files, which are to be printed, according to a predetermined classification condition and displays a file which corresponds to the predetermined classification condition and the remaining files which are displayed by a different display method. It is possible that the file and the remaining file are simultaneously displayed as an image on a screen.

The files which are to be printed may be any type of file as long as the file can be image-processed, for example, image files having various formats, including a bitmap format such as BMP, JPG, GIF, TIF, PNG and so on or a vector format, or text files such as Word, Excel, PowerPoint Presentation, PDF and so on.

The files which are to be printed may be stored in a memory (not illustrated) in the image forming apparatus 1, in a host device 2 (to be described later), in a USB memory 20, in a memory card 50, or in the like.

The image forming apparatus 1 includes a display part 100 and a controller 500. However, in alternative exemplary embodiments, the image forming apparatus 1 includes an image forming unit (not illustrated) having at least one of a printing unit (not illustrated), a scanning unit (not illustrated) to scan a document, and a facsimile unit (not illustrated) to transmit and receive a data through wire or wireless communication devices.

The display part 100 may display operations of the controller 500. The display part 100 may be provided as a liquid crystal display (LCD), a plasma display panel (PDP), or the like. The display part 100 displays a list of the files, which are to be printed, by different display methods according to a classification condition. For example, the display part 100 may display some of the files, which are to be printed on it's screen, in a first display method and the remaining files in a second display method. The first and second display methods may include a print preview, a schematic file name, a detailed file name, a slide show, small and large icons, or the like. In exemplary embodiments, the first display method may be different than the second display method. A selection menu for selecting the classification condition may be further displayed on the display part 100.

The controller 500 controls a classification of the files, which are to be printed, according to the classification condition and controls a display of the classified files which are displayed by different display methods on the display part 100.

In exemplary embodiments, the file list may be displayed on the display part 100 as a print preview, a file name, a slide show, large and small icons, or the like.

The file name may be formed of characters such as Korean alphabets, English alphabets, numerals, special characters, or a combination thereof. The file name may include a schematic view in which only a file name is displayed, and a detailed view which includes various meta information of the files, including a file name, the file type, the file size, the file generation and revision dates, and so on.

The slide show may continuously display the files in a slide pattern, for example. The icons represent the files as simplified pictures or symbols so that a user can access the files through a Graphic User Interface (GUI).

The print preview provides a user with a preview image or a thumbnail image which is rendered to have a relatively low resolution and a relatively small size as compared with that of an original image, so that the user can quickly recognize the contents of the files which are to be printed. However, the print preview display method requires reading and rendering of the original images, and therefore may cause a significant burden on a system including an image forming apparatus 1.

However, in an exemplary embodiment of the present general inventive concept, if a user desires a first file which corresponds to a classification condition, such as a first display method, and the first file is listed among a plurality of files, the first file is displayed by the first display method, and the remaining files within the plurality of files are displayed by a second display method. The first and second display methods may include a print preview, a schematic file name, a detailed file name, a slide show, small and large icons, or the like. In exemplary embodiments, the first display method may be different than the second display method. Therefore, a burden on the system including the image forming apparatus 1 would be reduced and a time required to display the file list would also be reduced.

The image forming apparatus 1 further includes a user input part 200 and a memory 300 in which the predetermined classification condition is stored. However, in an exemplary embodiment, when the predetermined classification condition is not stored in the memory 300, a selection menu including a plurality of classification conditions is displayed on the display part 100. A user can then select one of the plurality of classification conditions displayed on the display part 100 through the user input part 200.

The user input part 200 is provided so that a user can input therethrough a command to display a list of the files which are to be printed. The inputted command is transmitted to the controller 500, and then the controller 500 controls a process of classifying the files, making a list of the files and displaying the list. The user input part 200 is provided so that a user can select one classification condition of the plurality of classification conditions which are displayed on the display part 100. The user input part 200 may be provided as a control panel (not illustrated) of the image forming apparatus 1, however, in alternative exemplary embodiments the user input part 200 may be provided as an input part (not illustrated) of the host device 2.

The predetermined classification condition is stored in the memory 300 to allow the controller 500 access to the predetermined classification condition. However, in an exemplary embodiment, when the predetermined classification condition is not stored in the memory 300, the controller 500 controls a display of the selection menu on the display part 100 for a user to select one classification condition of the plurality of classification conditions. The selected classification condition is then stored in the memory 300.

The memory 300 may employ a flash memory or a hard disk drive, etc. provided in the image forming apparatus 1.

The image forming apparatus 1 further includes an interface part 410 and a memory slot 420.

The interface part 410 transmits files which are to be printed and which are provided from an external device, for example, the host device 2 or a USB memory 20 to the controller 500. The host device 2 may be connected to the interface part 410 through a network, or through a local connection such as a serial bus or a parallel bus. However, the present general inventive concept is not limited thereto. The host device 2 may be provided as a computer (not illustrated) which can store and process the files which are to be printed, and transmit the files to the image forming apparatus 1. In exemplary embodiments, a user may manipulate the input part (not illustrated) of the host device 2 to control operations of the image forming apparatus 1 through the host device 2.

In an exemplary embodiment, the memory slot 420 is provided external to the image forming apparatus 1. An external storage such as the memory card 50, a USB memory stick or the like is mounted to the memory slot 420. However, if the external storage is mounted to the memory slot 420, files which are to be printed and are stored in the external storage may be transmitted to the controller 500.

The controller 500 controls the display part 100 to display the list of the files to be printed corresponding to the classification condition and the list of the remaining files together on the same screen, wherein the files corresponding to the classification condition and the remaining files may include different display methods.

To this end, the controller 500 includes a list making part 510 which reads files which are to be printed according to a list making command and makes a file list, and a file retrieving part 520 which retrieves attribute information of the files in the file list, and a comparing part 530 which compares the attribute information of the files with the classification condition in order to classify the files which are to be printed.

The list making part 510 reads the files to be printed and makes the file list if the list making command is received through the user input part 200. The file list made by the list making part 510 is temporarily stored in the memory 300 and may be referred to by the file retrieving part 520 and/or the comparing part 530.

The file retrieving part 520 retrieves the attribute information of the files included in the file list made by the list making part 510. Here, the attribute information may include a format of the files, a file generation date, presence of a particular character string included in a file name or meta information, presence of a fax communication, resolution, color, or the like. Here, the meta information refers to the attribute information of the file which is stored as ASCII or binary values in a header part of the file. The file retrieving part 520 may retrieve the meta information and find the attribute information of a file without retrieving all of the files within the file list, thereby decreasing a retrieving time.

The comparing part 530 compares whether the attribute information retrieved by the file retrieving part 520 corresponds to the classification condition stored in the memory 300. In an exemplary embodiment, the comparing part 530 continuously classifies the files having the attribute information which corresponds to the classification condition and/or the files having the attribute information which does not correspond to the classification condition.

The controller 500 controls the display part 100 to display the classified files in different display methods. For example, the files having the attribute information corresponding to the classification condition may be displayed by a first display method, such as a print preview, and the remaining files may be displayed by a second display method, such as by a file name. In exemplary embodiments, this process may be continuously performed for every file included in the file list.

If a command is inputted through the user input part 200 from a user during the above processes, for example, the list making and displaying processes, the controller 500 suspends the above processes, and then processes the inputted command. At this time, an interrupt is transmitted to the controller 500 by a user through the user input part 200 to suspend the processes.

The image forming apparatus 1 further includes a printing part 10 which prints an image processed by the controller 500 from the files which are to be printed on a printing medium using a developer or ink. The printing part 10 may print the image onto the printing medium in various methods, for example, by a thermal transfer method or an ink-jet method, however the present general inventive concept is not limited thereto.

In alternative exemplary embodiments, the image forming apparatus 1 includes an image forming unit (not illustrated) having at least one of a printing unit (not illustrated), a scanning unit (not illustrated) to scan a document, and a facsimile unit (not illustrated) to transmit and receive a data through wire or wireless communication devices.

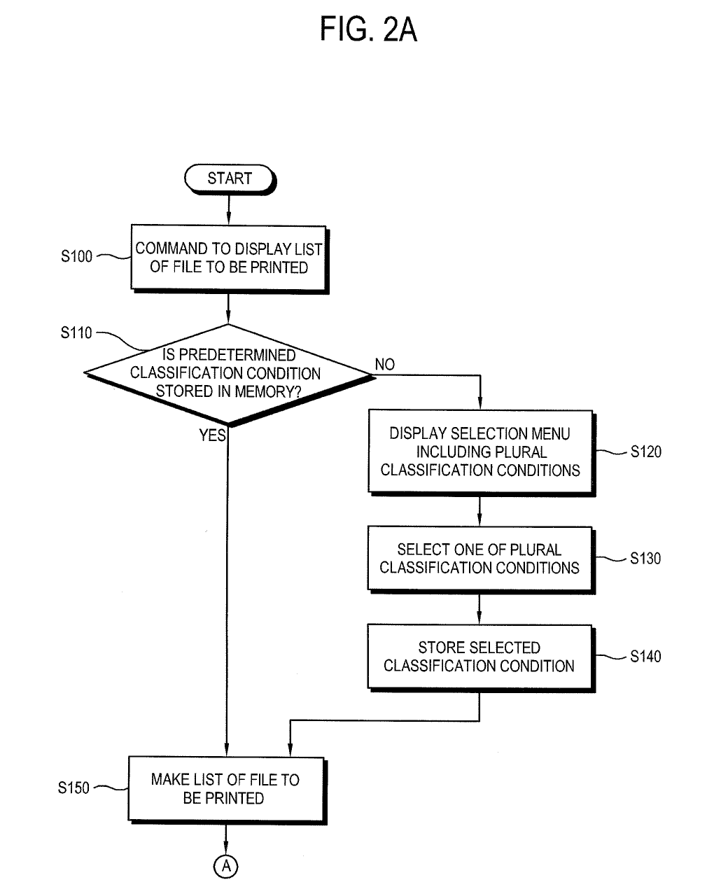

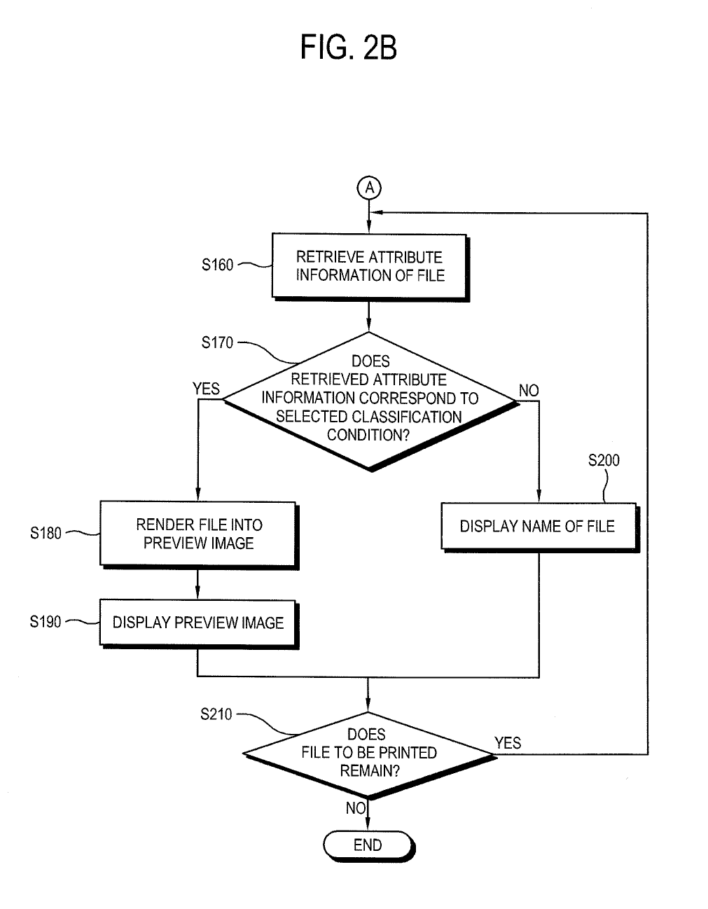

Hereinafter, a method of displaying a list of files which are to be printed in the image forming apparatus 1, according to an exemplary embodiment of the present general inventive concept, will be described with reference to FIGS. 1, 2A, 2B, and 3.

The method of displaying the file list according to the present general inventive concept includes the following steps, determining whether or not a classification condition of a file which is to be printed corresponds to one of a plurality of display methods and displaying the list of the files which correspond to the classification condition in a particular display method, and displaying the list of the remaining files in a display method different than the particular display method.

For example, the list of the file having a BMP image format as the classification condition may be displayed by a print preview display method, and the list of the remaining files may be displayed in a file name method. In this case, it is determined whether or not the file corresponds to the BMP image format as the classification condition. If so, the list of the file is displayed by the print preview display method; and if not, the list of the file is displayed by the file name display method. However, in exemplary embodiments, the classification condition and the display methods may be determined by various other methods which may reduce a burden on an image forming apparatus 1.

A user gives a command to the controller 500 through the user input part 200 in order to display the list of the files which are to be printed on the display part 100 (S100).

Then, the controller 500 accesses the memory 300 to determine whether or not the classification condition of the files, which are to be printed, is stored in the memory 300 (S100).

If the classification condition is not stored in the memory 300, the controller 500 then controls the display part 100 to display a selection menu including a plurality of classification condition (S120).

The user selects one classification condition of the plurality of classification conditions, for example, a classification condition that a file corresponds to a BMP format (S130).

Then, the controller 500 stores the selected classification condition in the memory 300 (S140).

However, if the classification condition is stored in the memory 300, the list making part 510 reads the files which are to be printed and makes a list of the files (S150). The file list made by the list making part 510 is stored in the memory 300 and is then referred to in the following processes.

The file retrieving part 520 retrieves attribute information included in the file list (S160).

The comparing part 530 compares and/or determines whether or not the retrieved attribute information corresponds to the classification condition, for example, whether the file attribute information corresponds to the BMP format (S170).

If the attribute information corresponds to the classification condition, the controller 500 renders the file which is to be printed into a preview image (S180), and then displays the preview image on the display part 100 (S190).

If the attribute information does not correspond to the classification condition, for example, if the file attribute information corresponds to a JPG format, the controller 500 displays a file name of the file on the display part 100 (S200).

If displaying one file is completed, the controller 500 then determines whether or not another file which is to be printed remains and repeats the above processes until all of the files which are to be printed are displayed on the display part 100 (S210).

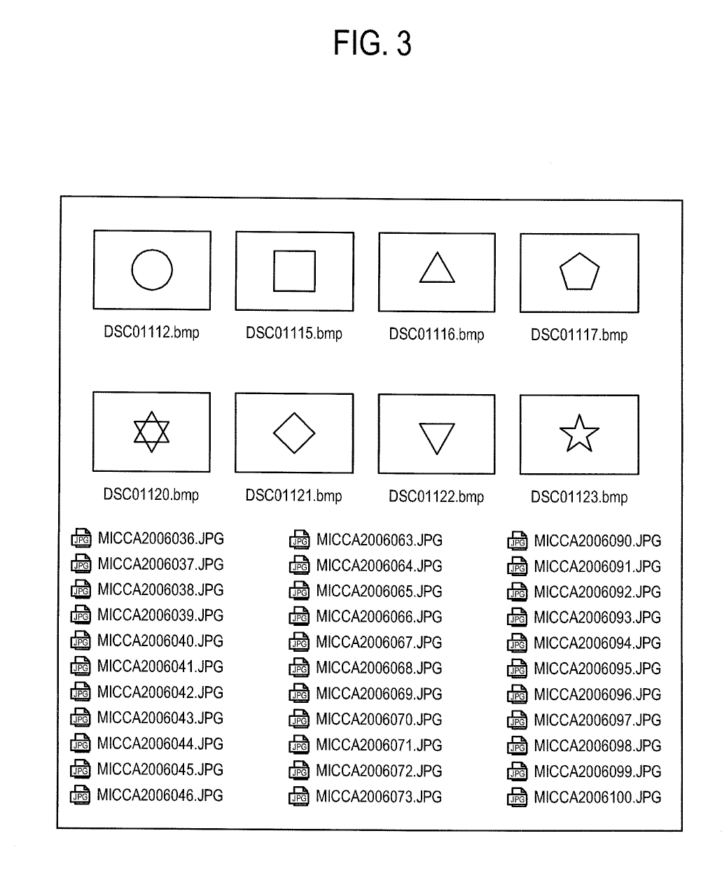

After the above processes are completed, as illustrated in FIG. 3, the list of the files which are to be printed having the BMP format is displayed as a preview image on a first part of the display part 100, and at the same time, the list of the other remaining files having different formats is displayed as a file name on a second part of the display part 100. In exemplary embodiments, the first and second part of the display part 100 may be adjacent to each other. In alternative exemplary embodiments, the first part of the display part 100 may be disposed separate from the second part of the display part 100.

During the above mentioned processes, if the controller 500 receives an interrupt through the user input part 200, the controller suspends the processes, and then resumes the processes according to a process command.

The display method of the image forming apparatus may be provided as a software driver. In this case, the display method may be stored in a computer-readable medium such as a compact disc (CD) or a digital video disc (DVD).

As described above, according to the present general inventive concept, lists of files which are to be printed can be classified according to a predetermined condition and the files may be displayed together on the same screen by different display methods. Accordingly, a user can easily retrieve his or her desired file.

Further, a display method such as a print preview display method which may cause a significant burden on a system including an image forming apparatus can be selectively employed for only a list of a particular file, thereby eliminating or reducing the burden and also decreasing a time for displaying an entire file list.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of displaying a file list in an image forming apparatus, the method comprising:
determining a classification condition of a file, which is to be printed, corresponding to a first display method to display the file list of the files which are to be printed; and
displaying the file list of the file corresponding to the classification condition by the first display method, and at the same time, displaying a file list of remaining files by a second display method, the second display method is different from the first display method.

2. The method according to claim 1, wherein the first and second display methods are selected among a print preview, a schematic file name, a detailed file name, a slide show, a large icon, and a small icon.

3. The method according to claim 2, wherein the first display method comprises the print preview, and the second display method comprises any display method other than the print preview display method.

4. The method according to claim 1, wherein the classification condition is inputted through the image forming apparatus or through a host device connected to the image forming apparatus.

5. The method according to claim 4, wherein the classification condition comprises at least one among a format of the file which is to be printed, a file generation date, presence of a predetermined character string included in a file name or meta information, presence of fax communication, resolution, and color.

6. The method according to claim 1, wherein the file, which is to be printed, is stored in at least one of a memory provided in the image forming apparatus, a portable memory which is connectable to the image forming apparatus, and a host device which is connected to the image forming apparatus.

7. An image forming apparatus, comprising:
a display part on which a first and second list of a file, which are to be printed, is displayed; and
a controller which controls a display of the first list of a file which corresponds to a predetermined condition simultaneously with a display of the second list of a file which does not correspond to the condition, the second list displayed on the display part by a different display method than the first list.

8. The image forming apparatus according to claim 7, wherein the different display methods are selected among a print preview, a schematic file name, a detailed file name, a slide show, a large icon, and a small icon.

9. The image forming apparatus according to claim 8, wherein the first list of the file which corresponds to the predetermined condition is displayed as the print preview, and the second list of the file which does not correspond to the predetermined condition is displayed in any display method other than the print preview display method.

10. The image forming apparatus according to claim 7, further comprising:
a printing part which prints an image processed from the first and/or second list onto a printing medium.

11. A method of displaying a list in an image forming apparatus, the method comprising:
receiving a signal representing a list of one or more files;
comparing the signal with a classification condition corresponding to a first display method;
displaying the signal using the first display method when the signal corresponds to the classification condition and using a second display method when the signal does not correspond to the classification condition,
the second display method being displayed simultaneously with the first display method.

12. The method according to claim 11, wherein the first and second display methods are selected among a print preview, a schematic file name, a detailed file name, a slide show, a large icon and a small icon.

13. The method according to claim 11, wherein the classification condition is inputted through the image forming apparatus and/or through a host device connected to the image forming apparatus.

14. The method according to claim 13, wherein the classification condition comprises at least one among a format of the file which is to be printed, a file generation date, presence of a predetermined character string included in a file name or meta information, presence of fax communication, resolution, and color.

15. An image forming apparatus, comprising:
an image forming unit; and
a controller which receives a file signal representing a file list of one or more files, determines whether each file within the file list corresponds to a plurality of conditions, transmits a first signal when a file corresponds to a first condition and a second signal when a file corresponds to a second condition,
wherein the first signal represents a first display method and the second signal represents a second display method, the first display method displayed simultaneously with the second display method.

16. The image forming apparatus according to claim 15, wherein the first and second display methods are selected among a print preview, a schematic file name, a detailed file name, a slide show, a large icon, and a small icon.

17. The image forming apparatus according to claim 16, wherein the first display method comprises the print preview, and the second display method comprises any display method other than the print preview display method.

18. An image forming system, comprising:
an image forming apparatus including an image forming unit and a controller which receives a file signal representing a file list of one or more files, determines whether each file within the file list corresponds to a plurality of conditions, transmits a first signal when a file corresponds to a first condition and a second signal when a file corresponds to a second condition, wherein the first signal represents a first display method and the second signal represents a second display method, the first display method displayed simultaneously with the second display method; and
a host which is connected to the image forming apparatus to control the image forming apparatus.

19. The image forming system according to claim 18, wherein the first and second display methods are selected among a print preview, a schematic file name, a detailed file name, a slide show, a large icon, and a small icon.

20. The image forming system according to claim 19, wherein the first display method comprises the print preview, and the second display method comprises any display method other than the print preview display method.
